(19) United States
(12) Patent Application Publication
(10) Pub. No.: US 2024/0278931 A1
(43) Pub. Date: Aug. 22, 2024

(54) Landing Advisor System for Aircrafts

(71) Applicants: Hunter Max McCray, Dearborn, MI (US); Kas Kasravi, West Bloomfield, MI (US)

(72) Inventors: Hunter Max McCray, Dearborn, MI (US); Kas Kasravi, West Bloomfield, MI (US)

(21) Appl. No.: 18/171,364

(22) Filed: Feb. 19, 2023

(51) Int. Cl. B64D 45/04

(52) U.S. Cl. CPC B64D 45/04; B64D 2045/008

(57) ABSTRACT

A landing adviser system for aircrafts comprising of a main housing, a microcontroller installed within the main housing, an environmental sensor array connected to the main housing, where the environmental sensor array electronically communicates with the microcontroller, a portable power source in the proximity of the main housing, where the portable power source provides electrical power to the microcontroller and the sensor array, a landing data collected by the environmental sensor array, where the landing data is communicated to the microcontroller, and a communication module for communicating the landing data from the microcontroller to the pilot of an aircraft. The environmental sensor array comprises an anemometer, an optical sensor and range finder, a thermometer, a hygrometer, a penetrometer, a gyroscope, and a global positioning system. The system further comprises an external sensor post, a beacon, algorithms for computing wind gusts and turbulence around nearby structures, and a padded carrying case.

### BACKGROUND OF THE INVENTION

### Field of the Invention

The present invention relates generally to aviation, and specifically to providing information to a pilot pertinent to the landing conditions in an uncontrolled airspace.

### Background

A majority of aircraft accidents involving fatalities and hull loss occur during the approach and landing phases of a flight. While such accidents may be caused by mechanical problems or pilot error, many are caused by adverse or unknown landing conditions, such as wind, gusts, visibility, and ground conditions. Aircrafts land in controlled or uncontrolled airspaces. The landing conditions are generally well-known in controlled airspace because such airspaces are closely monitored and landing conditions are communicated to the pilots by air traffic controllers. Landing in uncontrolled airspaces are often more perilous because the reliable and recent landing conditions are not known to the pilot. Such landings may take place in distant fields with very little or no information about the landing conditions.

An example of such landings is rescue helicopters attempting to land at the site of an emergency for rapid evacuation of the injured. The lack of information about the landing conditions in such cases can be unsafe and detrimental to the safety of the parties involved. In particular, helicopters are susceptible to dynamic rollover during taking off or landing. For dynamic rollover to occur, some factors have to first cause the helicopter to roll or pivot around a skid, or landing gear wheel, until its critical rollover angle is reached. Then, beyond this point, main rotor thrust continues the roll and recovery is impossible. If the critical rollover angle is exceeded, the helicopter rolls on its side regardless of the corrections made by the pilot. Dynamic rollover begins when the helicopter starts to pivot around its skid or wheel. This can occur for a variety of reasons, including the skid or wheel contacts a fixed object while hovering sideward, or if the gear is stuck in ice, soft asphalt, or mud. Dynamic rollover may also occur if the pilot does not use the proper landing or takeoff technique or while performing slope operations. Unexpected high gusts can also lead to rotor lift imbalance, leading to dynamic rollover. In the case of rescue helicopters any unsafe landing condition can lead to further injuries or death or may lead to landing the helicopter at a location further away, which detrimentally delays the care needed by the injured.

While all aircrafts' safety is at risk at uncontrolled airspaces, helicopters are especially susceptible due to aforementioned reasons. Such risks can be avoided or minimized with the availability of reliable and recent information about landing conditions.

Currently, there are a number of solutions for providing landing conditions in uncontrolled airspace to the pilots. Some of these solutions attempt to extrapolate the landing conditions at nearby locations, but these solutions fail to meet the needs of the industry because such information, especially about wind direction and gusts, are not accurate. Other solutions attempt to ascertain the landing conditions by personnel at the sight of landing, but these solutions are similarly unable to meet the needs of the industry because such personnel lack the knowledge and the instrumentation required to provide accurate information to the pilot. Further, weather conditions often change rapidly, therefore it is essential for any landing condition information to be recent.

It would be desirable to have a system that enables untrained ground personnel to obtain accurate and recent landing information in uncontrolled airspaces and convey this information to a pilot at the time of landing. Furthermore, it would also be desirable to have a system that requires minimal or no training by the ground personnel involved. Still further, it would be desirable to have a system that assists emergency personnel to automatically capture the landing conditions at the site of an emergency and convey this information to the pilot of a rescue helicopter.

### SUMMARY OF THE INVENTION

The present invention advantageously fills the aforementioned deficiencies by providing landing advisor system for aircrafts, which provides an environmental sensor array to capture and analyze the current landing conditions at a location in an uncontrolled airspace, requiring minimal training by the personnel, and communicate the landing data to a pilot attempting landing at that location.

The present invention is a system together with associated components, where the system is made up of the following components: a main housing, a microcontroller, an environmental sensor array, a portable power source, a landing data, and a communication module. These components are connected as follows: the microcontroller is connected to the environmental sensor array, the communication module, and the portable power source, where these components are enclosed in the main housing. The environmental sensor array captures the landing data and forwards the landing data to the communication module via the microcontroller. The portable power source provides electrical power to the microcontroller, the environmental sensor array, and the communication module.

The present invention may also have one or more of the following components: the environmental sensor array comprising an optical sensor and range finder, a global positioning system, a thermometer, a hygrometer, a camera, and a gyroscope. A sensor post that extends the location and height of the sensors. The main housing comprises a secure shell, a control panel, foldable legs, a carrying handle, a beacon, padding, and a carrying case. The portable power source is a battery, optionally removeable and/or rechargeable. The microcontroller has algorithms to infer additional landing information from the data collected by the environmental sensor array; for example, computation of gusts from wind speed/direction, and computation of local turbulence by analyzing wind flow around obstacles such as trees, hills, and buildings.

The present invention system is unique when compared with other known systems and solutions in that it provides a portable means for gathering, analyzing, and communicating landing conditions to a pilot attempting to operate in an uncontrolled airspace; minimal training is required by the ground personnel; the landing conditions are transmitted to the pilot in real-time; and the landing information received by the pilot is accurate and timely.

The present invention is unique in that the overall architecture of the system is different from other known systems. More specifically, the present invention system is unique due to the presence of: (1) an environmental sensor array that captures pertinent data about the landing conditions in real-time; (2) algorithms that compute and infer advanced landing information such as gusts and turbulence around buildings, trees, and other structures; (3) the information about the landing conditions are transmitted to the pilot in real-time; and (4) the system is portable and easy to set up and operate with minimal training.

Among other things, it is an object of the present invention to provide a landing advisor system for aircrafts that does not suffer from any of the problems or deficiencies associated with prior solutions.

It is an objective of the present invention to provide a portable system for capturing, analyzing, and transmitting landing conditions in an uncontrolled airspace to a pilot to maximize safe flight operations, landing, and rescue.

It is further an objective of the present invention to be easy to set up and require minimal training by the ground personnel.

It is still further an objective of the present information to transmit the landing conditions to the pilot in real-time.

Further still, it is an objective of the present invention to provide a system that is economical to produce, easy to manufacture and repair, easy to store and transport, and durable under adverse weather conditions.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF DRAWINGS

FIG. 1 illustrates a perspective view of the most basic version of the present invention.

FIG. 2 illustrates a perspective view of the environmental sensor array, microcontroller, communication module, and the power source situated within a main housing.

FIG. 3 illustrates a schematic diagram of the environmental sensor array, the microcontroller, the power supply, and the communication module.

FIG. 4 illustrates a perspective view of the present invention with the removeable battery.

FIG. 5 illustrates a perspective view of the present invention with extended legs and carrying handle.

FIG. 6 illustrates a perspective view of the present invention with folded legs.

FIG. 7 illustrates a perspective view of the present invention with the external sensor post and wire connection.

FIG. 8 illustrates a perspective view of the present invention with the external sensor post and wireless communication.

FIG. 9 illustrates a perspective view of the present invention inside a portable package.

FIG. 10 illustrates a landing site where the present invention is used to communicate landing information to ground personnel and an aircraft.

FIG. 11 illustrates plan and elevation views of air flow streamlines around an object.

FIG. 12 illustrates a simple view of the visual indicator.

FIG. 13 illustrates an exemplary representation of a controller-pilot data link communications.

FIG. 14 illustrates a flow chart of the use of the present invention.

### DETAILED DESCRIPTION OF THE INVENTION

The present invention is generally directed to a landing advisor system for aircrafts in uncontrolled airspaces, and more specifically to emergency helicopter pilots requiring to operate in uncontrolled airspaces and unknown landing conditions.

In its most complete version, the system of the present invention comprises a plurality of environmental sensors capturing the environmental conditions at an intended aircraft landing site, such as air temperature and humidity, wind speed and direction, ground softness, and the presence of obstacles such as hills, trees, and artificial structures that affect the wind behavior. Using algorithms known to a person having ordinary skill in the art additional information is inferred such as gusts, turbulence, and dew point. The captured information about the landing site are compiled and wirelessly transmitted to the pilot of an aircraft. The present invention is packaged in manner to simplify storage, transportation, set up, and operations by the ground personnel responsible for operating the present invention on the ground.

In the present invention “aircraft” refers to any controlled flying object such as but not limited to fixed wing, rotary wing, helicopter, remotely piloted aircraft, balloon, drones and as such. Further, “pilot” refers to an any entity in control of an aircraft, such has a human pilot on board the aircraft, a human pilot remotely controlling the aircraft, or an auto-pilot system. Still further, “landing data” refers to any information required by a pilot to make a safe landing in an uncontrolled airspace, including direct sensor data such as temperature and wind speed, and inferred information such as wind gusts and turbulence around obstacles.

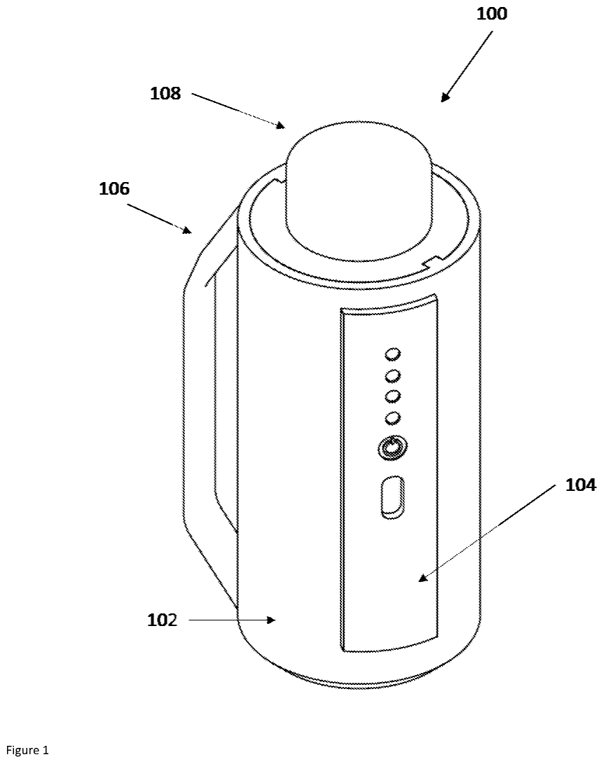

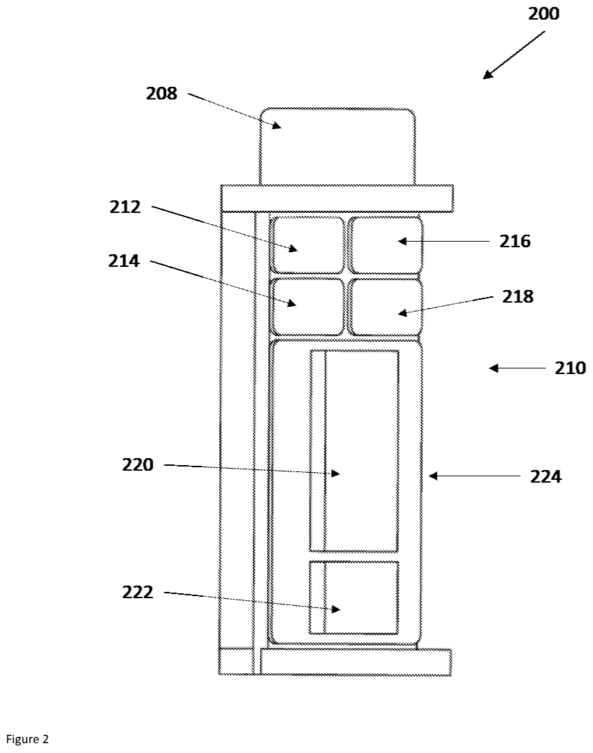

The figures herein follow a numbering convention in which the first digit or digits correspond to the drawing figure number and the remaining digits identify an element or component in the drawing. Similar elements or components between different figures may be identified using similar digits. For example, 145 may reference element “45” in FIG. 1, and a similar element may be referenced as 245 in FIG. 2. Elements shown in the various figures herein can be added, exchanged, and/or eliminated to provide a number of additional examples of the present disclosure. In addition, the proportion and the relative scale of the elements provided in the figures are intended to illustrate the examples of the present disclosure and should not be taken in a limiting sense.

FIG. 1 illustrates the landing adviser system for aircrafts 100 comprising a main housing 102, a control panel 104, a carrying handle 106, and an optical sensor and range finder 108 positioned at the top of the landing advisor system for aircrafts 100 in this embodiment. The utility of the optical sensor and range finder 108 is to three-dimensionally identify the position and size of any obstacles in the landing area that may interfere with the aircraft's landing process. The control panel 104 comprises common controls and displays known to a person having ordinary skill in the art such as ON/Off button, reset button, charging port, and status display screen.

FIG. 2 illustrates the internal components of the landing adviser system for aircrafts 200 having an environmental sensor array 210 further comprising the optical sensor and range finder 208, a global positioning system 212, a thermometer 214, a hygrometer 216, and a gyroscope 218. The landing adviser system for aircrafts 200 also comprises a microcontroller 220, a communication module 222, and a portable power source 224. The aforementioned components making up the environmental sensor array 210 are connected to the microcontroller 220, which compiles and processes the environmental information and runs algorithms to infer wind gusts, air turbulence, and dew point. The information received and processed by the microcontroller 220 are electronically transferred to the communication module 222, which communicates the said information to a pilot. The microcontroller 220 is also connected to the control panel 104 shown in FIG. 1. The portable power source 224 provides electrical power to the aforementioned components. A person having ordinary skill in the art would recognize that the aforementioned components can be located differently than shown in the figures to accommodate specific physical and functional requirements.

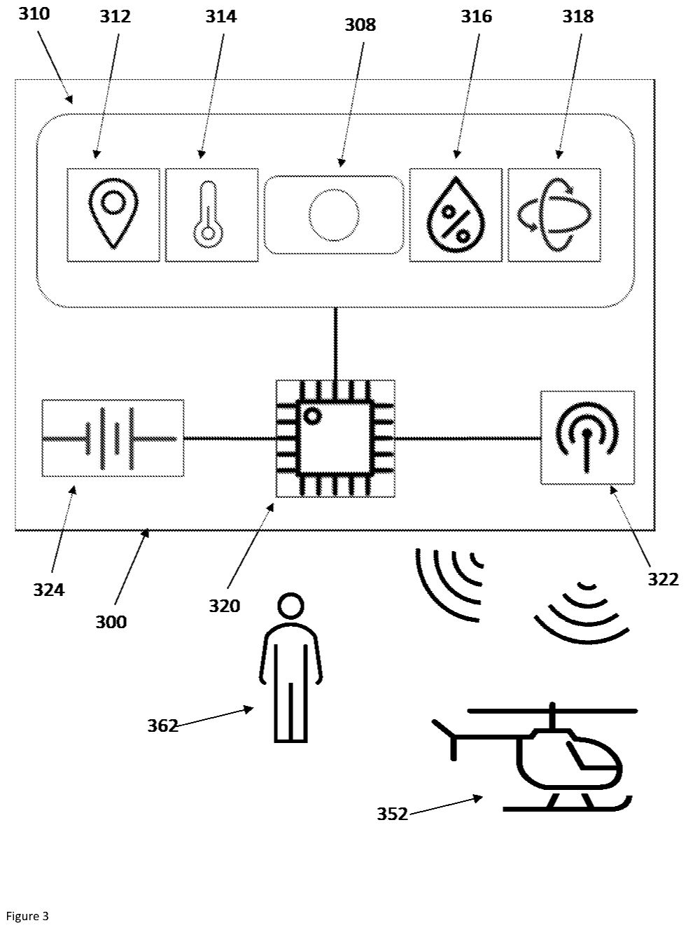

FIG. 3 illustrates the schematic of the internal components of the landing adviser system for aircrafts 300 relative to a ground personnel 362 and an aircraft 352. The environmental sensor array 310 comprises the global positioning system 312, the thermometer 314, the hygrometer 316, the gyroscope 318, and the optical sensor and range finder 308. Collectively, these sensors capture environmental conditions and transmit the information to the microcontroller 320, which collects and further analyzes the information to generate a landing data to provide to the pilot of the aircraft 352 via the communication module 322. The same landing data is optionally transmitted to the ground personnel 362. The portable power supply 324 provides electrical power to the aforementioned components.

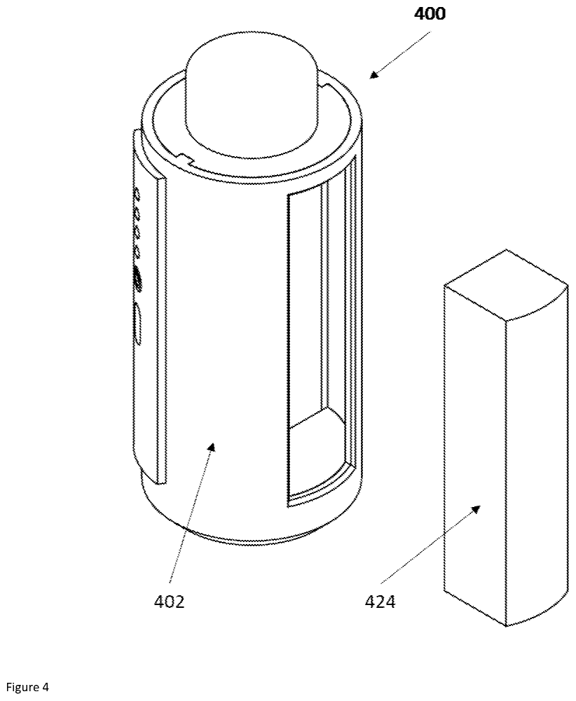

FIG. 4 illustrates the landing adviser system for aircrafts 400, the main housing 402, and the portable power supply 424. As shown the portable power supply 424 is removable and can be replaced with a similar power sources. The portable power supply 424 is a battery. The utility of replacing the portable power supply 424 is extended operational time of the landing advisor system for aircrafts 400.

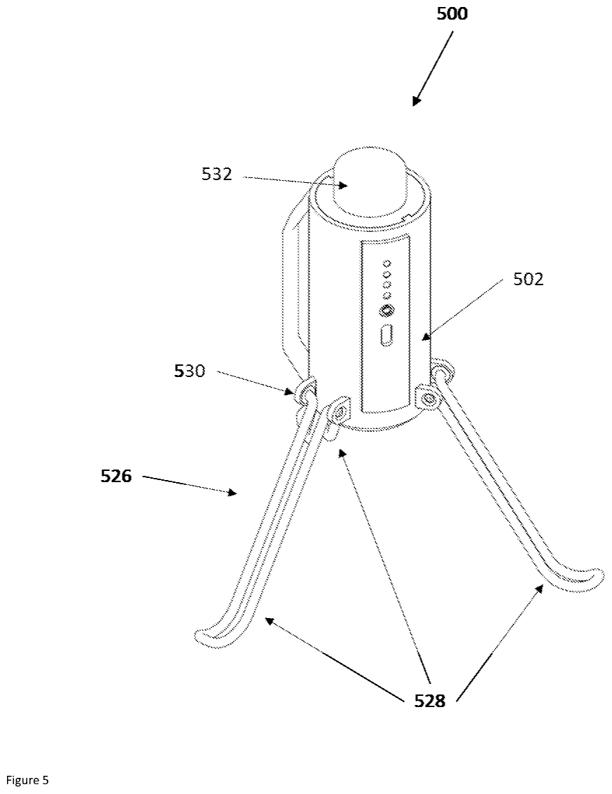

FIG. 5 illustrates the landing adviser system for aircrafts 500 with a portable stand 526 comprising of a plurality of legs 528 and a plurality of leg hinges 530 for attaching the legs 528 to the main housing 502. The utility of the portable stand 526 is to stabilize the landing adviser system for aircrafts 500 during use. The leg hinges 530 allow the legs 528 to fold against the main housing 502. In the embodiment shown in FIG. 5 a camera 532 is located atop the landing adviser system for aircrafts 500. The camera 532 is used to capture images of the landing site and transmitted to the pilot.

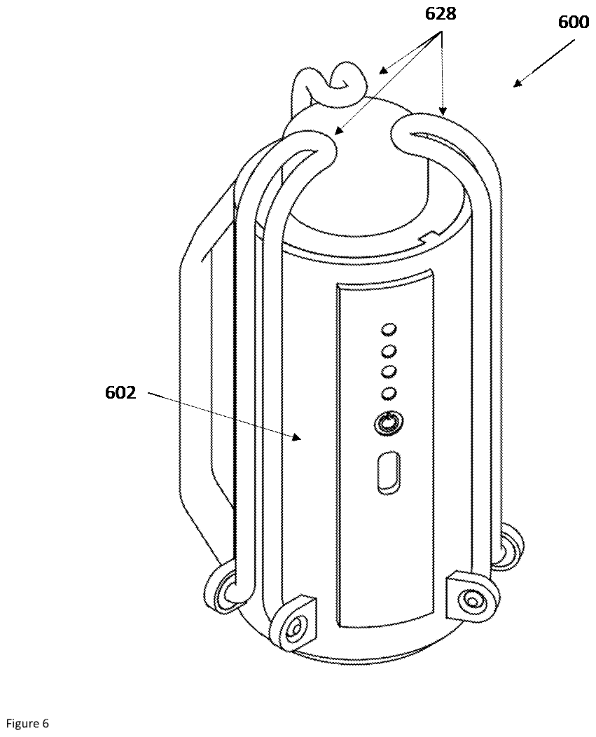

FIG. 6 illustrates the landing adviser system for aircrafts 600 with the legs 628 in the folded position relative to the main housing 602 to reduce the overall size of the device, protect the device, and facilitate transportation.

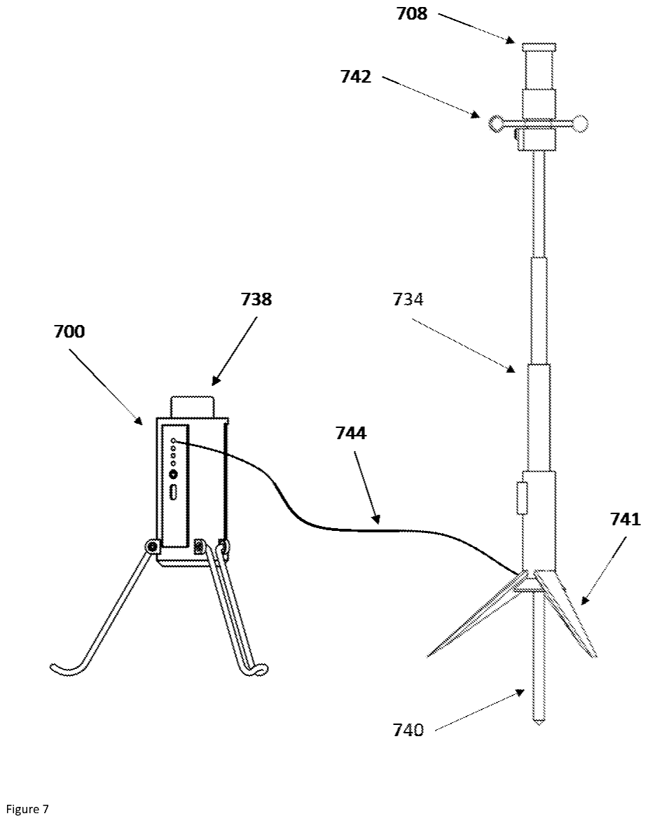

FIG. 7 illustrates an embodiment of the landing adviser system for aircrafts 700 having a beacon 738 at the top of the device. The utility of the beacon is to signal the pilot and render the landing location more visible. All embodiments of the present invention can have external sensors such as those presented in an external sensor post 734. In this illustration, the external sensor post 734 is telescopic with post legs 741 for stability. The illustrated external sensor post 734 has the optical sensor and range finder 708 and an anemometer 742 atop. A utility of the external sensor post 734 is to raise the height of certain sensors such as the optical sensor and range finder 708 and the anemometer 742 to enhance the range and accuracy of the readings. In this illustration a penetrometer 740 is attached to the bottom of the external sensor post 734 to measure the firmness of the ground. The firmness of the ground is of high utility to helicopter pilots to determine the likelihood of a dynamic rollover by the helicopter. The landing adviser system for aircrafts 700 and the external sensor post 734 are connected to each other, where the connection can be a sensor post communication wire 744.

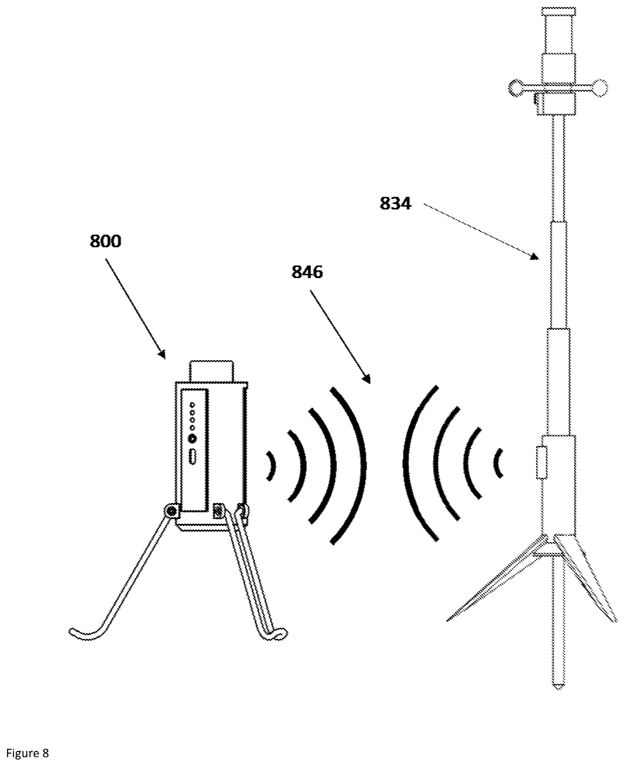

FIG. 8 illustrates the preferred embodiment of the present invention where the landing adviser system for aircrafts 800 and the external sensor post 834 communicate wirelessly via sensor post wireless signals 846.

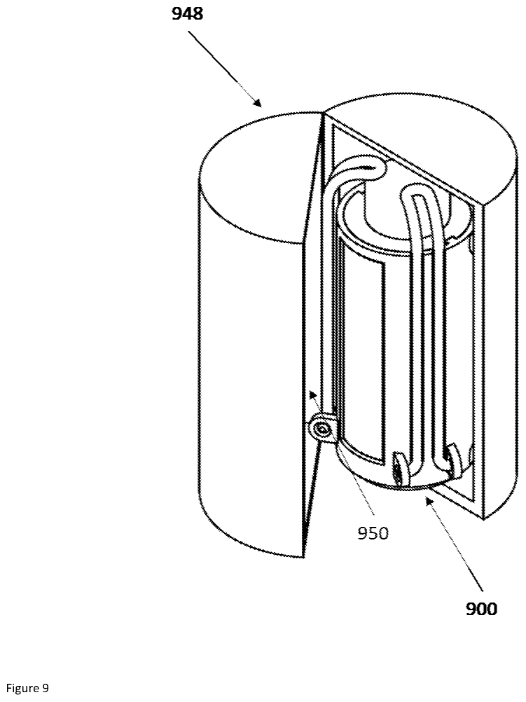

FIG. 9 illustrates the landing adviser system for aircrafts 900 positioned within a portable package 948, where the internal walls of the portable package 948 have padding 950. The utility of the portable package 948 is safe transportation of the device. In the preferred embodiment of the present invention the portable package 948 is waterproof, shockproof, fireproof, and resistant to excessively high and low temperatures.

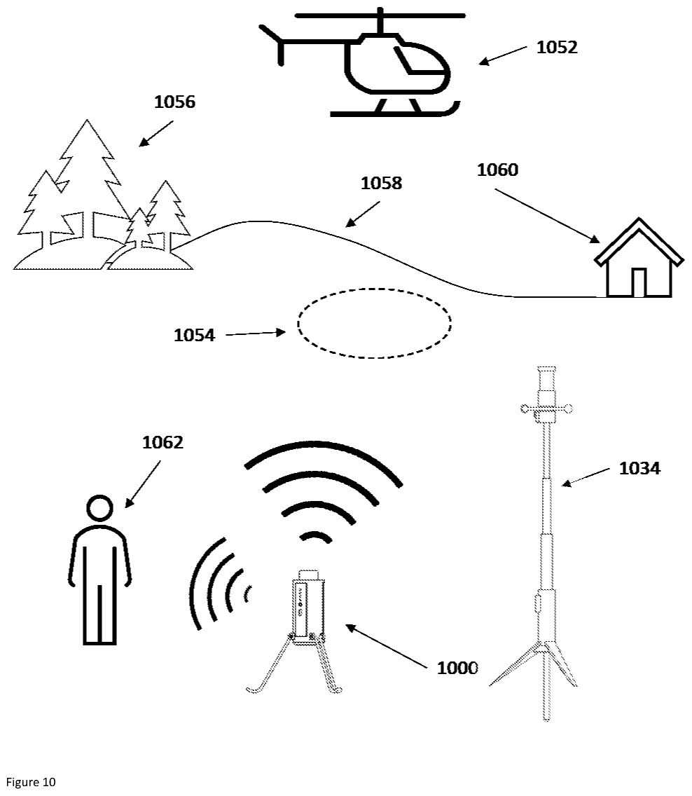

FIG. 10 illustrates a landing site where the landing adviser system for aircrafts 1000 is used to help the pilot of the aircraft 1052 safely land at a target landing location 1054. This exemplary site demonstrates the ground personnel 1062 position the landing adviser system for aircrafts 1000 and the external sensor post 1034 close to the target landing location 1054. A typical site may have trees and shrubs 1056, ground unevenness and hills 1058, and buildings and other structures 1060, all of which affect the surrounding air flow and present a safety risk to the aircraft 1052 when landing. At this exemplary site, the landing adviser system for aircrafts 1000 along with the associated external sensor post 1034 collect information about conditions of the landing site, analyze the information, and transmit the landing data to the pilot of the aircraft 1052 and optionally to ground personnel 1062. The landing data transmitted to the pilot is used to determine the target landing location 1054 is safe for landing. If not, an alternative location will be assessed.

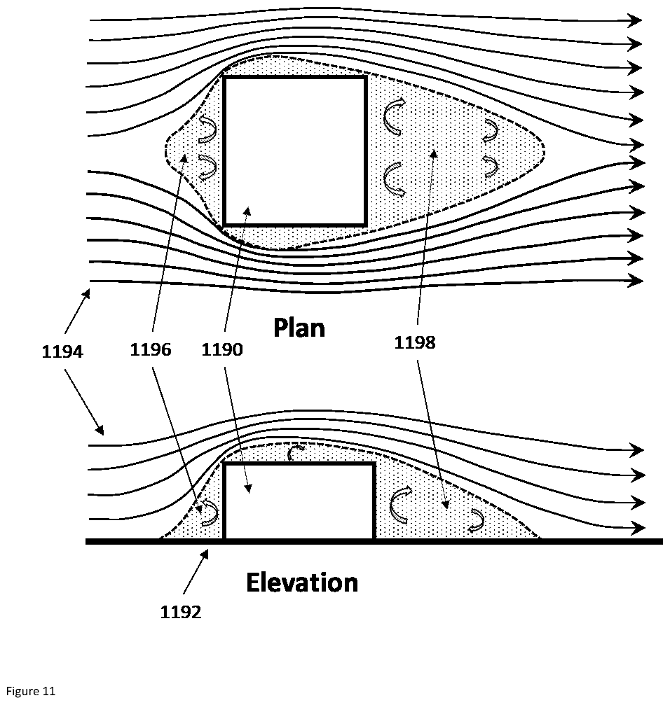

A person having ordinary skill in the art recognizes that the information collected by the sensors of the present invention can be analyzed to infer additional useful information that lead to a more complete landing data for a pilot. For example, changes in wind speed and direction are used to compute wind gusts. Similarly, the information about the flatness of the ground and the presence of obstacles such as trees, hills, and buildings can be analyzed to identify and predict the presence of high winds, rapidly changing winds, and turbulence, which will be very useful to a pilot. FIG. 11 illustrates examples of air flow around a structure, using both plan and elevation views of the same obstacle. In this example, an obstacle 1190 located on ground level 1190 is subject to an air flow 1194 as shown. The obstacle 1192 can be a tree, a hill, an unevenness on the ground, or an any artificial structure. The principles of fluid dynamics cause the pressure and speed of the air flow 1194 to change around the obstacle 1190, resulting faster or slower air streams, as shown in FIG. 1, and possibly a leading turbulence 1196, a trailing turbulence 1198, or similar turbulences above or to the sides of the obstacle 1190. The present invention's ability to sense wind speed and direction, as well as recognizing various obstacles in the area via the aforementioned camera and optical sensor and range finder are used to compute the characteristics of undesirable turbulence and wind patterns as part of the landing data. The landing data that is enriched with this additional information helps pilots make safer landing decisions.

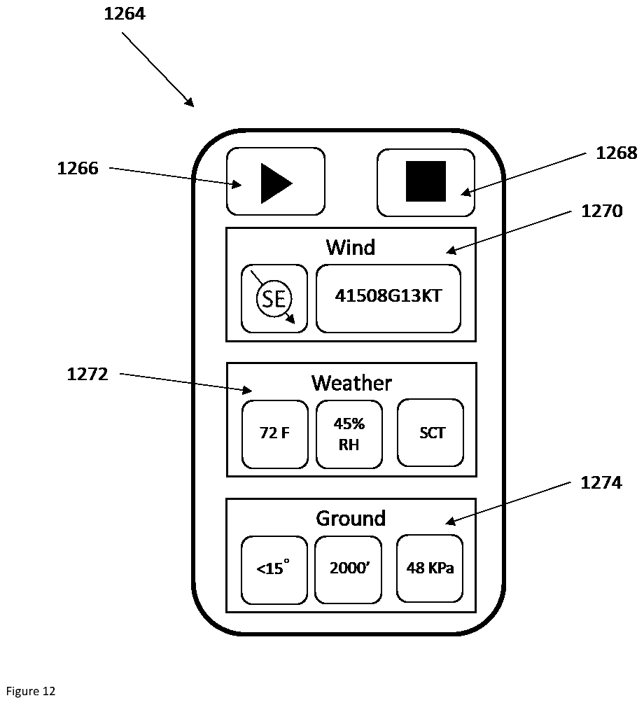

The aforementioned landing data are communicated to the pilots wirelessly, such as by short message service (SMS), via an app and wireless internet connection, via controller-pilot data link communications (CPDLC) or similar means. FIG. 12 illustrates a visual indicator 1264 that is the user interface of a simple app that shows the landing data on the screen of the present invention's control panel 104 (as shown in FIG. 1), or on the mobile phones of the ground personnel and pilots. As shown in FIG. 12, the displayed landing data includes a start button 1266, a stop button 1268, wind data 1270, weather data 1272, and ground conditions 1274.

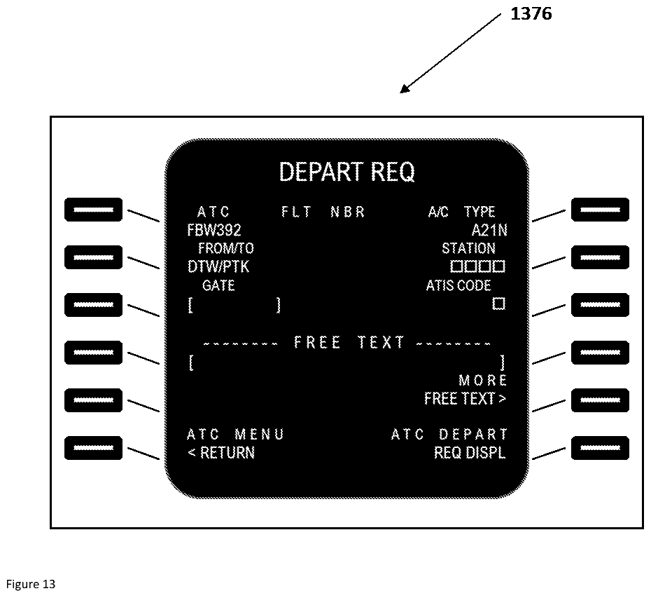

FIG. 13 illustrates a simple example of the location of the landing site, the landing data, and other pertinent information shared with a pilot via a CPDLC screen 1376 in real-time. In this embodiment, the aforementioned communication module is configured to transmit information according to the CPDLC standards.

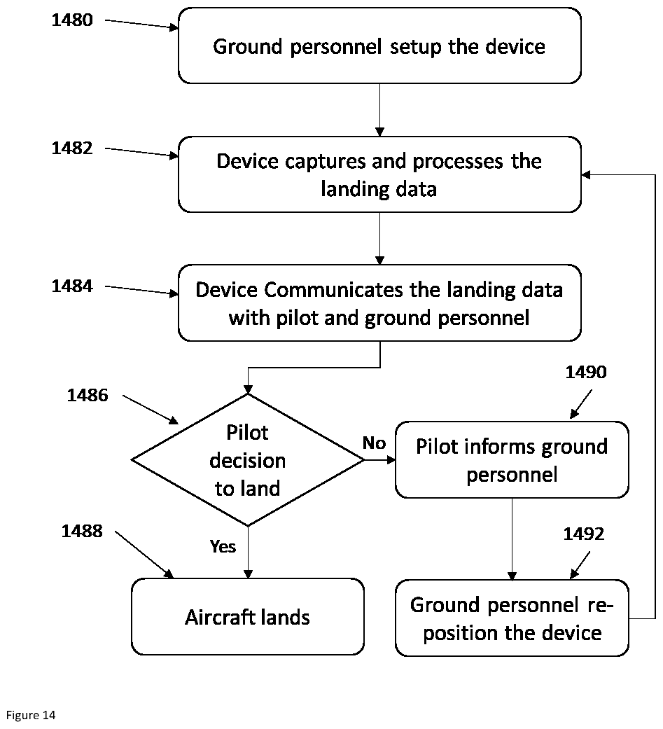

FIG. 14 illustrates the steps involved in using the device of the present invention, as follows:
Step 1480: Ground personnel arrive at the landing site and set up the device.
Step 1482: The device captures information about the landing location, analyzes and
processes the information, and compiles the landing data.
Step 1484: The device communicates the landing data with the pilot and optionally with the ground personnel.
Step 1486: The pilot reviews the landing data and decides whether to land or not.
Step 1488: The pilot lands the aircraft if the landing data is satisfactory.
Step 1490: The pilot informs the ground personnel if the landing data is not satisfactory.
Step 1492: The ground personnel identify a more favorable landing site, return to Step 1482, and reposition the device.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. A landing adviser system for aircrafts comprising:
a main housing;
a microcontroller installed within the main housing;
an environmental sensor array connected to the main housing, where the environmental sensor array electronically communicates with the microcontroller;
a portable power source in the proximity of the main housing, where the portable power source provides electrical power to the microcontroller and the environmental sensor array;
a landing data collected by the environmental sensor array, where the landing data is communicated to the microcontroller; and
a communication module for communicating the landing data from the microcontroller to the pilot of an aircraft.

2. The landing adviser system for aircrafts of claim 1, where the environmental sensor array comprises at least one of a global positioning system, a thermometer, an optical sensor and range finder, a camera, a hygrometer, an anemometer, an ultrasound, a penetrometer, and a gyroscope.

3. The landing adviser system for aircrafts of claim 2, where the landing data is the plurality of sensor data collected by the environmental sensor array.

4. The landing adviser system for aircrafts of claim 3, where the landing data comprises information pertinent to safe landing of aircrafts.

5. The landing adviser system for aircrafts of claim 4, where the anemometer is capable of detecting the direction and speed of wind and determining the characteristics of wind gusts.

6. The landing adviser system for aircrafts of claim 5, where the communication module is wireless and least one of a short messaging service and a controller-pilot datalink communication.

7. The landing adviser system for aircrafts of claim 6, where the microcontroller displays the landing data on a visual indicator.

8. The landing adviser system for aircrafts of claim 7, where the main housing is mounted on a portable stand.

9. The landing adviser system for aircrafts of claim 8, where the portable power source is a rechargeable battery.

10. The landing adviser system for aircrafts of claim 9, where the rechargeable battery is interchangeable.

11. The landing adviser system for aircrafts of claim 10, where the main housing and the portable stand are folded into a portable package.

12. The landing adviser system for aircrafts of claim 11, where the portable stand protects the portable package when folded.

13. The landing adviser system for aircrafts of claim 12 provides a beacon.

14. The landing adviser system for aircrafts of claim 13, where the main housing is waterproof.

15. The landing adviser system for aircrafts of claim 14, where the main housing is shockproof.

16. The landing adviser system for aircrafts of claim 15, where the main housing is temperature resistant.

17. The landing adviser system for aircrafts of claim 16, where the main housing is fireproof.
